(19) United States
(12) Patent Application Publication
(10) Pub. No.: US 2023/0048210 A1
(43) Pub. Date: Feb. 16, 2023

(54) Suction toy

(71) Applicant: Dongguan Shuxintang Health Technology Co., Ltd., Dongguan (CN)

(72) Inventor: Jiafeng Chen, Teng (CN)

(73) Assignee: Dongguan Shuxintang Health Technology Co., Ltd., Dongguan (CN)

(21) Appl. No.: 17/980,585

(22) Filed: Nov. 4, 2022

(51) Int. Cl. A61H 9/00; A61H 7/00

(52) U.S. Cl. CPC A61H 9/0057; A61H 7/001; A61H 2201/01; A61H 2201/1246

(57) ABSTRACT

The present disclosure discloses a suction toy, including a shell, a printed circuit board (PCB), an actuating device, a piston, and a power supply. The shell is provided with a piston chamber; the piston chamber is communicated with an air inlet channel and an air outlet channel; the air inlet channel is provided with an air inlet, and the air outlet channel is provided with an air outlet; the shell is provided with a suction mouth; and the air inlet and the air outlet are both communicated with the suction mouth. Therefore, compared with the prior art, the suction toy can generate larger air flow and provide users with a better experience, and also has the advantages of difficulty in damage and longer service life.

### TECHNICAL FIELD

The present disclosure relates to the field of destress toys, in particular, to a suction toy.

### BACKGROUND

With the development of science and technology and the increase of people’s life stress, there are a variety of destress toys on the market. There is a destress toy at present, which can generate air flow by pulling an inner wall of a rubber chamber at a high speed through a motor, so that the air flow can be directed at some specific parts or skin to play a role of massage and destress.

However, this kind of destress toy still has shortcomings. Specifically, since it the air flow is generated by pulling the rubber at a high frequency through the motor, the service life of the rubber will be further shortened, and the pulled inner wall will be often broken. At the same time, the air flow generated by pulling the rubber inner wall is relatively small, which cannot provide users with a good use experience.

Therefore, it is necessary to study a new technical solution to solve the above problems.

### SUMMARY

In order to solve the defects and shortcomings in the prior art, the present disclosure provides a suction toy. Compared with the existing suction toy, the suction toy designed can generate larger air flow to provide users with a better experience. Meanwhile, the suction toy also has the advantages of difficulty in damage and longer service life.

In order to achieve the above-mentioned objective, the present disclosure adopts the following technical solution:

A suction toy includes a shell, and a PCB, an actuating device, a piston, and a power supply which are arranged in the shell; the shell is provided with a piston chamber matched with the piston; the PCB is electrically connected to the actuating device; and the actuating device is in actuating connection with the piston.

The piston chamber is communicated with an air inlet channel and an air outlet channel; and the air inlet channel is provided with a first check valve and an air inlet, and the air outlet channel is provided with a second check valve and an air outlet.

The shell is provided with a suction mouth in an upper end; and the air inlet and the air outlet are both communicated with the suction mouth.

As a preferable scheme, the actuating device includes a motor and a cam that is in actuating connection with the motor; a lower end of the piston is provided with a driven member matched with the cam; the driven member is provided with an actuating chamber; and the cam is movably arranged in the actuating chamber.

As a preferable scheme, the suction mouth is circular.

As a preferable scheme, the shell is elliptical, and a lower end face of the shell is a placement plane.

As a preferable scheme, the shell includes a left shell, a right shell, an upper cover, a pipe fitting, and a fixing member; the left shell and the right shell are assembled to form a mounting chamber; the piston chamber, the air inlet channel and the air outlet channel are all formed in the pipe fitting; the motor and the pipe fitting are fixed in the mounting chamber through the fixing member; and the fixing member is provided with a motor chamber corresponding to the motor.

As a preferable scheme, the shell is made of plastic, and an outer side face of the shell is wrapped with a silica gel layer.

As a preferable scheme, the first check valve includes a first valve body and a first cover body; the first valve body is provided with a first channel; the first cover body covers an entrance of the first channel; and the first cover body includes a first fixed shaft and a first deformation plane connected to one end of the first fixed shaft.

The second check valve includes a second valve body and a second cover body; the second valve body is provided with a second channel; the second cover body covers an entrance of the second channel; and the second cover body includes a second fixed shaft and a second deformation plane connected to one end of the second fixed shaft.

The first cover body and the second cover body are made of silica gel.

As a preferable scheme, a vibration motor is also arranged in the shell, and the PCB is in control connection with the vibration motor.

As a preferable scheme, the actuating device comprises a double-shaft motor, and the PCB is in control connection with the double-shaft motor.

As a preferable scheme, the shell is provided with flow guide portions corresponding to the air inlet of the air inlet channel and the air outlet of the air outlet channel.

Compared with the prior art, the present disclosure has significant advantages and beneficial effects. Specifically, according to the above technical solution, compared with the existing suction toy, the suction toy designed can generate larger air flow to provide users with a better experience. Meanwhile, the suction toy has a simple and ingenious overall structure, and the manufacturing process is simple, so that it is favorable for manufacturers to control the cost and is also favorable for users to repair the suction toy.

Then, the shell is made of plastic. Furthermore, compared with the existing suction toy that works by pulling a chamber wall (the chamber wall is generally a rubber layer), the suction toy of the present disclosure works by means of generating the air flow, so that it is more difficult to damage and has longer service life.

Moreover, the suction toy of the present disclosure has a small overall structure, is convenient for a user to carry and hold, and has a certain superiority in appearance.

In order to describe the structural features and effects of the present disclosure more clearly, the present disclosure is described in detail below in combination with the accompanying drawings and specific embodiments.

### BRIEF DESCRIPTION OF THE DRAWINGS

FIG. 1 is a schematic three-dimensional diagram of Embodiment I of the present disclosure;

FIG. 2 is another three-dimensional diagram of Embodiment I of the present disclosure;

FIG. 3 is a schematic sectional diagram of Embodiment I of the present disclosure;

FIG. 4 is a first schematic exploded diagram of Embodiment I of the present disclosure;

FIG. 5 is a partially enlarged diagram of FIG. 4.

FIG. 6 is a second schematic exploded diagram of an embodiment of the present disclosure;

FIG. 7 is a schematic diagram of an air feeding principle of Embodiment I of the present disclosure;

FIG. 8 is a schematic diagram of an air discharging principle of Embodiment I of the present disclosure;

FIG. 9 is a schematic three-dimensional diagram of Embodiment II of the present disclosure;

FIG. 10 is a schematic exploded diagram of Embodiment II of the present disclosure;

FIG. 11 is a sectional view of Embodiment II of the present disclosure; and

FIG. 12 is a schematic diagram of an air flow direction of Embodiment II of the present disclosure.

Reference numerals in the drawings:

10: shell; 101: left shell; 102: right shell; 103: upper cover; 104: pipe fitting; 105: fixing member; 1051: motor chamber; 11: piston chamber; 111: opening; 12: air inlet channel; 121: first check valve; 1211: first valve body; 1212: first cover body; 1213: first fixed shaft; 1214: first deformation plane; 122: air inlet; 13: air outlet channel; 131: second check valve; 1311: second valve body; 1312: second cover body; 1313: second fixed shaft; 1314: second deformation plane; 132: air outlet; 14: suction mouth; 15: placement plane; 16: flow guide portion; 20: PCB; 30: piton; 31: driven member; 311: actuating chamber; 40: power supply; 50: motor; 51: cam; and 60: vibration motor.

### DETAILED DESCRIPTION OF THE EMBODIMENTS

The technical solutions in the embodiments of the present disclosure will be clearly and completely described below in conjunction with the accompanying drawings. Apparently, the described embodiments are only preferred embodiments of the present disclosure.

It should be noted that when an element is referred to as being “fixed” to another element, it can be directly on the other element or an intermediate element may also exist. When one element is considered to be “connected” to another element, it can be directly connected to another element or there may be a central element at the same time. The terms “perpendicular”, “horizontal”, “left”, “right” and similar expressions used herein are for illustrative purposes only, and are not meant to be the only implementation modes.

Unless otherwise defined, all technical and scientific terms used herein are the same as meanings of general understandings of those skilled in the art of the present disclosure. The terms used in the description of the present disclosure herein are merely to describe the specific implementation modes, not intended to limit the present disclosure. The term “and/or” used herein includes any and all combinations of one or more related listed items.

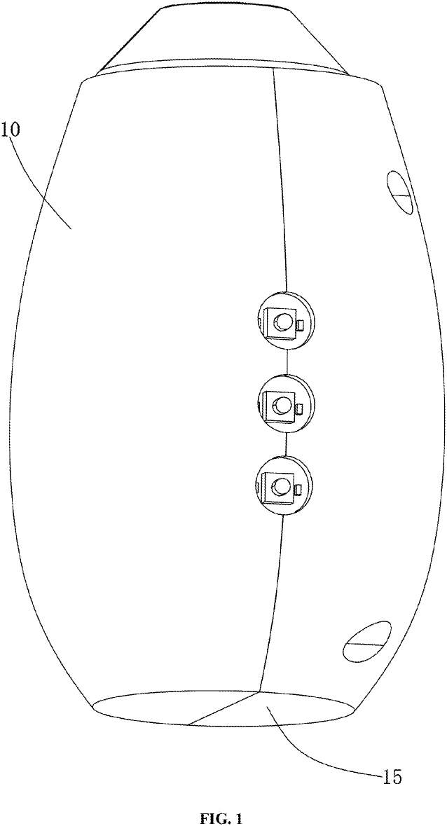

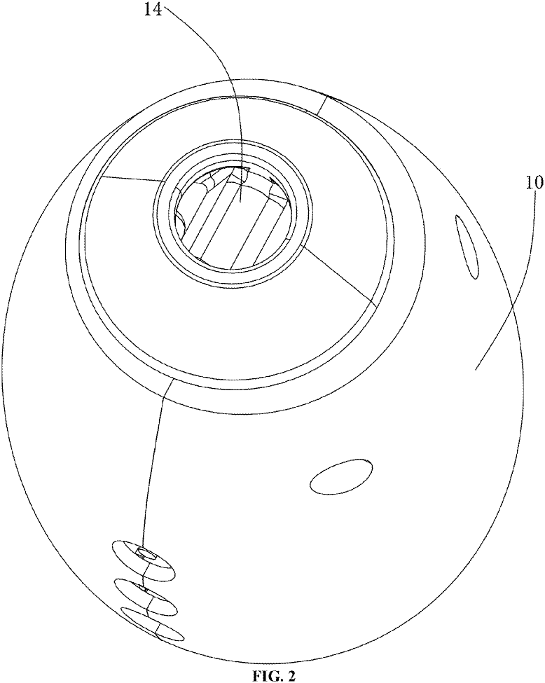

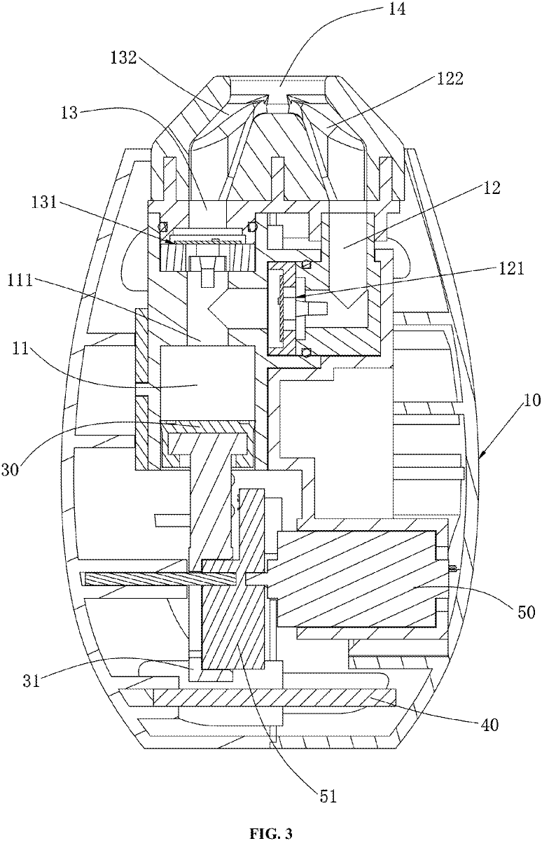

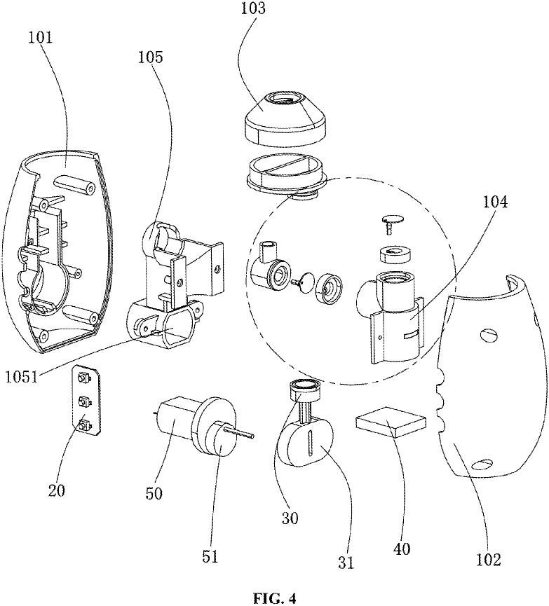

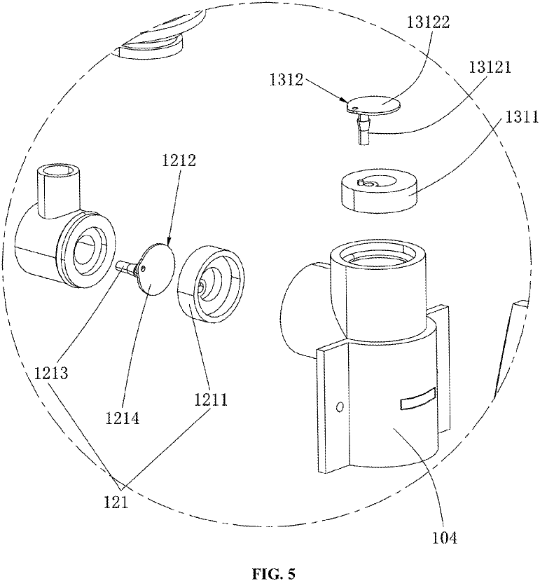

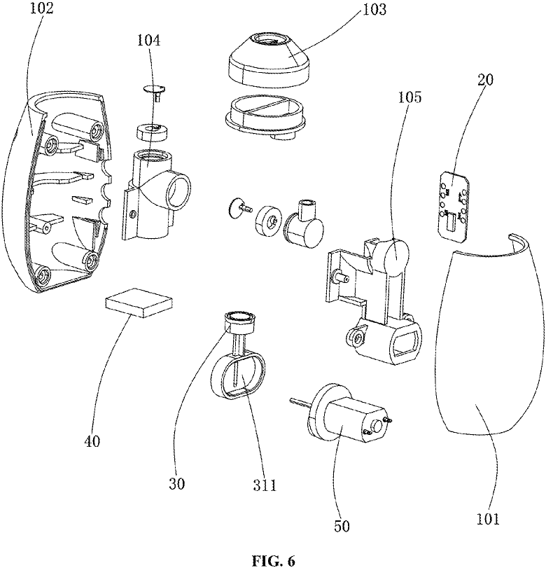

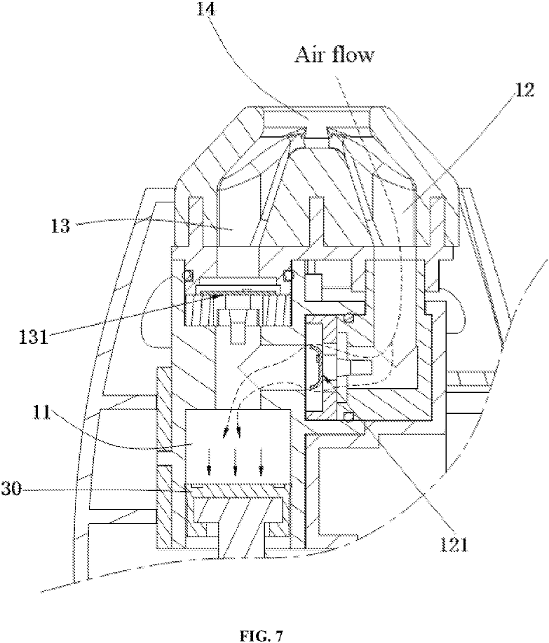

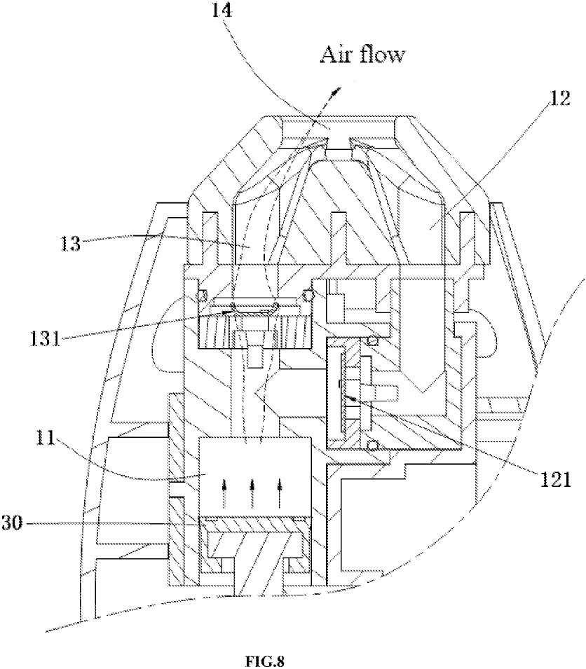

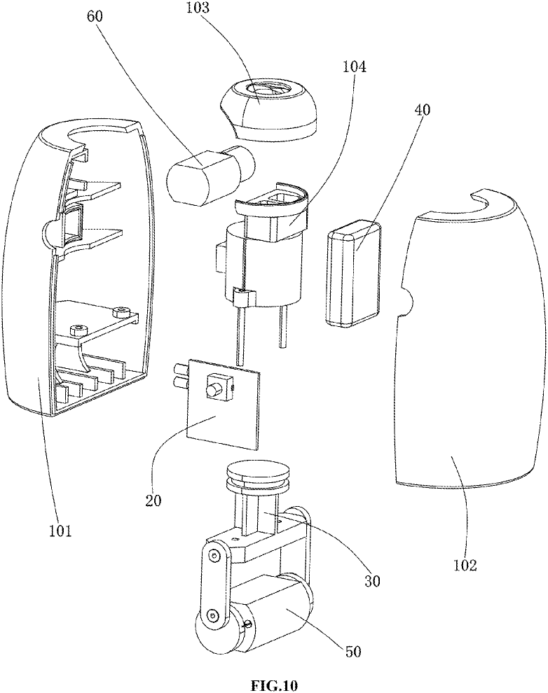

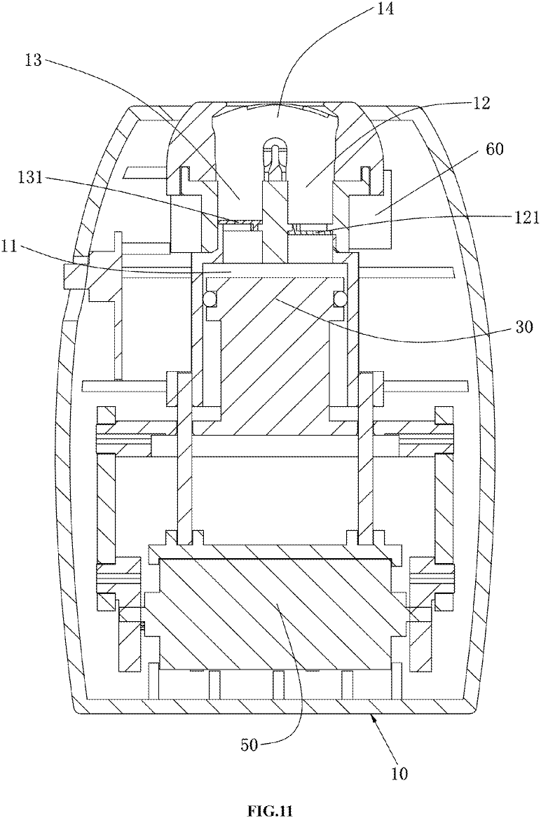

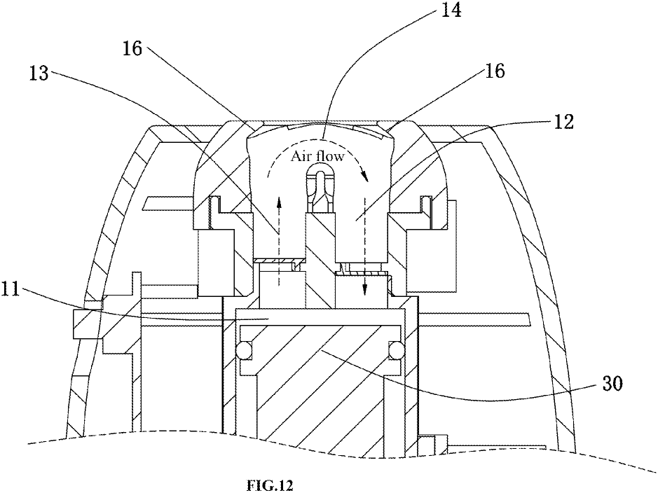

Referring to FIG. 1 to FIG. 12, two embodiments of the present disclosure are shown. Referring to FIG. 1 to FIG. 8, a suction toy in an embodiment of the present disclosure includes a shell 10, and a PCB 20, an actuating device, a piston 30, and a power supply 40 which are arranged in the shell 10. The shell 10 is provided with a piston chamber 11 matched with the piston 30. The PCB 20 is electrically connected to the actuating device. The actuating device is in actuating connection with the piston 30.

The piston chamber 11 is provided with an opening 111. The opening 111 is communicated with an air inlet channel 12 and an air outlet channel 13. The air inlet channel 12 is provided with a first check valve 121 and an air inlet 122, and the air outlet channel 13 is provided with a second check valve 131 and an air outlet 132.

The shell 10 is provided with a suction mouth 14 in an upper end; and the air inlet 122 and the air outlet 132 are both communicated with the suction mouth 14.

When the suction toy works, the actuating device drives the piston 30 to move in the piston chamber 11 in a reciprocating manner, thus achieving an air inlet action of the air inlet channel 12 and an air outlet action of the air outlet channel 13, and finally realizing “sucking” and “blowing” functions at the suction mouth 14. Compared with some existing suction toys where the air flow is pushed (generated) by means of pulling the chamber wall, the suction toy of the present disclosure generates air flow with a larger air volume to provide users with a better experience. Meanwhile, the suction toy of the present disclosure also has the advantages of simple and ingenious structure, convenient assembling and low manufacturing cost. Preferably, the suction mouth 14 is circular.

Specifically, the actuating device includes a motor 50 and a cam 51 that is in actuating connection with the motor 50. A lower end of the piston 30 is provided with a driven member 31 matched with the cam 51. The driven member 31 is provided with an actuating chamber 311. The cam 51 is movably located in the actuating chamber 311.

Preferably, the shell 10 is elliptical (egg-shaped), and a lower end face of the shell 10 is a placement plane 15. In actual applications, the shell 10 is usually made of plastic, and an outer side face of the shell 10 is wrapped with a silica gel layer. As such, since the shell 10 is made of plastic, the manufacturing is facilitated, and the manufacturing cost can also be saved. Meanwhile, the outer side face of the shell 10 is wrapped with the silica gel layer, so that the handfeel of the suction toy can be improved, and the comfort level of use of the suction toy is improved.

Specifically, the shell 10 includes a left shell 101, a right shell 102, an upper cover 103, a pipe fitting 104, and a fixing member 105. The left shell 101 and the right shell 102 are assembled to form a mounting chamber. The piston chamber 11, the air inlet channel 12 and the air outlet channel 13 are all formed in the pipe fitting 104. The motor 50 and the pipe fitting 104 are fixed in the mounting chamber through the fixing member 105. The fixing member 105 is provided with a motor chamber 1051 corresponding to the motor 50.

Further, the first check valve 121 includes a first valve body 1211 and a first cover body 1212. The first valve body 1211 is provided with a first channel. The first cover body 1212 covers an entrance of the first channel. The first cover body 1212 includes a first fixed shaft 1213 and a first deformation plane 1214 connected to one end of the first fixed shaft 1213.

The second check valve 131 includes a second valve body 1311 and a second cover body 1312. The second valve body 1311 is provided with a second channel. The second cover body 1312 covers an entrance of the second channel. The second cover body 1312 includes a second fixed shaft 1313 and a second deformation plane 1314 connected to one end of the second fixed shaft 1313. The first cover body 1212 and the second cover body 1312 are made of a deformable material (such as silica gel)

Of course, several control buttons used for controlling the start, stop and working power of the motor 50 are also arranged on the PCB 20. Meanwhile, the foregoing power supply 40 is usually a storage battery (such as a lithium battery). The storage battery is electrically connected to the PCB 20 and the motor 50. The PCB 20 is also provided with a charging jack for charging the storage battery.

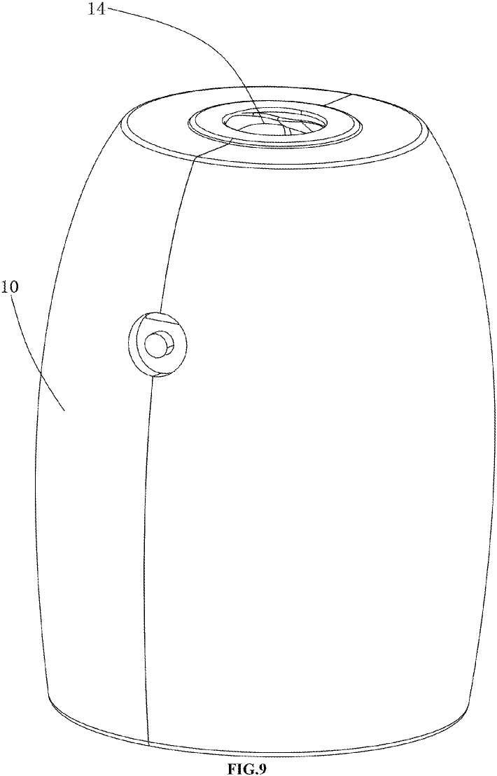

Further, referring to FIG. 9 to FIG. 12, Embodiment II of the present disclosure is shown. The principle of Embodiment II is roughly the same as that of Embodiment I, but differs from Embodiment I in the following:

In Embodiment II, the air inlet channel 12 and the air outlet channel 13 are both straight through. A vibration motor 60 is also arranged in the shell 10. The vibration motor 60 is in driving connection with a deflection member, so that when the vibration motor 60 works, the entire suction toy can achieve a high-frequency vibration effect. That is, the suction toy of the present disclosure also has a vibration massage function. The suction toy plays a role of massage when it is placed on the human skin. Meanwhile, the motor 50 is a double-shaft motor, two ends of which are in driving connection with swing arms which are in driving connection with a lower end of the piston 30, so that the piston 30 moves up and down.

Preferably, the shell 10 is provided with flow guide portions 16 corresponding to the air inlet of the air inlet channel 12 and the air outlet of the air outlet channel 13. Thus, part of the air flow is circulated at the suction mouth 14, and the massage effect is better.

The design point of the present disclosure is as follows: Compared with the existing suction toy, the suction toy of the present disclosure can generate larger air flow to provide users with a better experience. Meanwhile, the suction toy has a simple and ingenious overall structure, and the manufacturing process is simple, so that it is favorable for manufacturers to control the cost and is also favorable for users to repair the suction toy.

Then, the shell is made of plastic. Furthermore, compared with the existing suction toy that works by pulling a chamber wall (the chamber wall is generally a rubber layer), the suction toy of the present disclosure works by means of generating the air flow, so that it is more difficult to damage and has longer service life.

Moreover, the suction toy of the present disclosure has a small overall structure, is convenient for a user to carry and hold, and has a certain superiority in appearance.

The above descriptions are only preferred embodiments of the present disclosure, and do not limit the technical scope of the present disclosure. Therefore, any minor changes, equivalent changes and modifications made to the above embodiments according to the technical essence of the present disclosure still fall within the scope of the technical solutions of the present disclosure.

What is claimed is:

1. A suction toy, comprising a shell, and a printed circuit board (PCB), an actuating device, a piston, and a power supply which are arranged in the shell, wherein the shell is provided with a piston chamber matched with the piston; the PCB is electrically connected to the actuating device; the actuating device is in actuating connection with the piston;
the piston chamber is communicated with an air inlet channel and an air outlet channel; the air inlet channel is provided with a first check valve and an air inlet, and the air outlet channel is provided with a second check valve and an air outlet;
the shell is provided with a suction mouth in an upper end; and the air inlet and the air outlet are both communicated with the suction mouth.

2. The suction toy according to claim 1, wherein the actuating device comprises a motor and a cam that is in actuating connection with the motor; a lower end of the piston is provided with a driven member matched with the cam; the driven member is provided with an actuating chamber; and the cam is movably arranged in the actuating chamber.

3. The suction toy according to claim 1, wherein the suction mouth is circular.

4. The suction toy according to claim 1, wherein the shell is elliptical, and a lower end face of the shell is a placement plane.

5. The suction toy according to claim 2, wherein the shell comprises a left shell, a right shell, an upper cover, a pipe fitting, and a fixing member; the left shell and the right shell are assembled to form a mounting chamber; the piston chamber, the air inlet channel and the air outlet channel are all formed in the pipe fitting; the motor and the pipe fitting are fixed in the mounting chamber through the fixing member; and the fixing member is provided with a motor chamber corresponding to the motor.

6. The suction toy according to claim 1, wherein the shell is made of plastic, and an outer side face of the shell is wrapped with a silica gel layer.

7. The suction toy according to claim 1, wherein the first check valve comprises a first valve body and a first cover body; the first valve body is provided with a first channel; the first cover body covers an entrance of the first channel; the first cover body comprises a first fixed shaft and a first deformation plane connected to one end of the first fixed shaft;
the second check valve comprises a second valve body and a second cover body; the second valve body is provided with a second channel; the second cover body covers an entrance of the second channel; the second cover body comprises a second fixed shaft and a second deformation plane connected to one end of the second fixed shaft; and
the first cover body and the second cover body are made of silica gel.

8. The suction toy according to claim 1, wherein a vibration motor is also arranged in the shell, and the PCB is in control connection with the vibration motor.

9. The suction toy according to claim 1, wherein the actuating device comprises a double-shaft motor, and the PCB is in control connection with the double-shaft motor.

10. The suction toy according to claim 1, wherein the shell is provided with flow guide portions corresponding to the air inlet of the air inlet channel and the air outlet of the air outlet channel.
